(19) United States
(12) Patent Application Publication
(10) Pub. No.: US 2010/0331483 A1
(43) Pub. Date: Dec. 30, 2010

(54) CURABLE POLYMER MIXTURES

(75) Inventors: Christoph Briehn, Zeilarn (DE); Martin Bortenschlager, Bergkirchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/918,590

(22) PCT Filed: Jan. 30, 2009
(86) PCT No.: PCT/EP09/51039

§ 371 Date: Aug. 20, 2010

(30) Foreign Application Priority Data
Feb. 20, 2008 (DE) 102008000353.0

(51) Int. Cl. C09D 183/06

(52) U.S. Cl. 524/588

(57) ABSTRACT

Polymer blends containing polymers or low molecular weight compounds containing groups of the formula ≡Si—O—C(R¹)(R²)(R³) where R¹, R², and R³ are hydrogen, halogen, or an organic radical, not more than two of which are hydrogen, may be cured thermally or photochemically to produce solvent resistant polymers. The curing may take place in the absence of water.

The invention relates to thermally curable polymer blends, to a method for the curing of polymer blends, to crosslinking products produced by heating the polymer blends, and to a method for producing coatings, silane-crosslinked moldings, and adhesives and sealants from the polymer blends.

Siloxanes and organic polymers which carry hydrolyzable silyl groups and are cured by condensation of the silanol groups formed on ingress of (atmospheric) moisture are state of the art. A disadvantage of these polymers is the fact that the cure rate is determined by the diffusion of the water to the hydrolyzable silyl groups in the polymer to be cured. The curing of thick layers in particular frequently represents a very slow process, which, for a multiplicity of applications, makes it more difficult or even impossible to employ these polymers. The search is therefore on for siloxanes and organic polymers which can be cured rapidly even in a thick layer, preferably in the absence of (atmospheric) moisture.

The rapid curing of thick polymer layers in the absence of (atmospheric) moisture is accomplished, for example, by the method of hydrosilylation, where SiH-functional siloxanes are reacted with vinyl-functional siloxanes or organic polymers in the presence of a noble metal catalyst. A disadvantage of the polymers curable by hydrosilylation is that the noble metal catalysts needed for their curing are very high-priced raw materials. The high costs of the noble metal catalysts are a particular problem on account of the fact that the catalysts generally remain in the product and cannot be recovered.

Advantageous, therefore, would be a noble-metal-free crosslinking mechanism which operates even in the absence of (atmospheric) moisture.

U.S. Pat. No. 7,135,418 B1 describes the deposition of SiO₂ layers on semiconductor substrates by Atomic Layer Deposition (ALD) or Rapid Vapor Deposition (RVD) of alkoxy-silanols. In a first process step, a semiconductor substrate is coated with a metal precursor (e.g., trimethylaluminum). The coated surface is then exposed for a short time, for the deposition of SiO₂, repeatedly to an atmosphere of a silicon dioxide-releasing precursor which carries tert-pentoxysilyl groups. At elevated temperature, the silicon dioxide is formed, for example, from tris(tert-pentoxy)silanol with elimination of products including water and alkenes.

Don Tilley et al. in Adv. Mater, 2001, 13, 331-335 teach the preparation of mixed oxides by the thermo-lysis of molecular precursors which carry tris(tert-butoxy)silyl groups. The mixed oxides are formed at temperatures between 90° C. and 150° C. without ingress of (atmospheric) moisture, with elimination of isobutylene and water.

Utilizing the thermal decomposition of alkoxysilanols or alkoxysilyl groups for preparing crosslinked siloxanes and organic polymers is not described in the literature.

WO 2005/035630 A1 describes tert-butoxy-functional silicone resins.

Y. Abe et al. (Bull. Chem. Soc. Japan 1969, 42, 1118-1123) describe tert-butoxysil(ox)anes and also their condensation products, which through uncatalyzed thermal treatment undergo transition to high molecular mass compounds.

J. Beckmann et al. in Appl. Organomet. Chem. 2003, 17, 52-62 describe the synthesis and uncatalyzed thermal condensation of tert-butoxysilanols.

M. Sakata et al. in J. Photopolym. Sci. Techn. 1992, 5, 181-190 teach the preparation of tert-butoxy-functional siloxanes by condensation of di(acetoxy)-di(tert-butoxy)silane. The polymers are cured in the presence of photoacids by electron bombardment to SiO₂.

The invention provides crosslinkable polymer blends (A) comprising

at least one compound (V) which carries at least one alkoxysilyl group of the general formula [1],

≡Si—O—C(R¹)(R²)(R³) [1]

and also a catalyst (K) selected from a Brönsted acid, Brönsted base, Lewis acid and Lewis base,

where
R¹, R², and R³ are hydrogen, a halogen, a radical attached via a carbon atom, where the radicals R¹, R², and R³ may be joined to one another, or a divalent radical which is attached via a carbon atom and joins two alkoxysilyl groups of the general formula [1], with the proviso that not more than two of the radicals R¹, R², and R³ are hydrogen, and alkoxysilyl radicals of the formula ≡Si—O—CH₂—R⁴ are excepted, and
R⁴ is an unbranched aliphatic hydrocarbon radical having 1-12 carbon atoms,
   with the exclusion of polymer blends (A) which form SiO₂ on crosslinking.

In one preferred embodiment of the invention, the alkoxysilyl group of the general formula [1] adopts the general formula [2],

═Si(R⁵)—O—C(_{R′})(R²)(R³) [2]

where
R⁵ is hydrogen, a halogen, an unsubstituted or substituted aliphatic or aromatic hydrocarbon radical having 1-12 carbon atoms, an OH group, an —OR⁶ group, —OC(O)R⁶ group or a metal-oxy radical M—O—,
R⁶ is hydrogen, an unsubstituted or substituted aliphatic or aromatic hydrocarbon radical having 1-12 carbon atoms, and
M is a metal atom, any free valences of which are satisfied by ligands.

The polymer blends (A) can be cured by heating, even in a thick layer, without ingress of (atmospheric) moisture and in the absence of high-priced noble metal catalysts. In particular, high temperatures are not required for this curing.

In the general formula [1], the silicon atoms, at the valences identified by ≡Si, can be satisfied with any desired radicals.

The radicals R¹, R², and R³ are, in particular, hydrogen, chlorine, an unsubstituted or substituted aliphatic or aromatic hydrocarbon radical or a siloxane radical attached via a carbon atom, or are a carbonyl group —C(O)R⁶, a carboxylic ester group —C(O)OR⁶, a cyano group —C≡N or an amide group —C(O)NR⁶₂, where R⁶ adopts the definition indicated above. The radicals R¹, R², and R³ preferably have 1 to 12, more particularly 1 to 6, carbon atoms. Also preferred are high molecular mass radicals which contain (polymeric) repeating units. With particular preference the radicals R¹, R², and R³ are methyl, ethyl, propyl, vinyl, phenyl or carboxyl radicals —C(O)OCH₃.

Two or three of the radicals R¹, R², and R³ may be joined to one another; for example, R² and R³ may have been formed from a diol.

The radicals R⁵ are preferably hydrogen, chlorine, methyl, ethyl, propyl, phenyl, methoxy, ethoxy, acetoxy, vinyl, OH, a metal-oxy radical —O—M or a radical —CH₂—W, where W is a heteroatom, such as N, O, P or S, for example, and the free valences on the hetero-atom are satisfied by alkyl and/or aryl radicals having preferably 1 to 10 carbon atoms.

The radical R⁶ is preferably hydrogen, methyl, ethyl, propyl, vinyl or phenyl.

The radicals M denote preferably metal atoms selected from lithium, sodium, potassium, calcium, magnesium, boron, aluminum, zirconium, gallium, iron, copper, titanium, zinc, bismuth, cerium, and tin. In the case of polyvalent metals, the free valences on the metal are satisfied by halides, preferably chloride and bromide, alkoxide groups, preferably methoxy, ethoxy or isopropoxy radicals, alkyl radicals, preferably methyl, ethyl, and phenyl groups, carboxylic acid radicals, preferably carboxylic acid radicals having 2-16 carbon atoms, or common unidentate and multidentate complex ligands which are employed typically in organometallic synthesis (e.g., acetylacetone).

The radicals ≡Si—O—C(R¹) (R²) (R³) preferably carry a hydrogen in the β position relative to the oxygen. Examples of preferred alkoxysilyl groups of the general formula [1] are groups of the formulae [3]-[9],

≡Si—O—C(CH₃)₃ [3],

≡Si—O—C(CH₃)₂C₂H₅ [4],

≡Si—O—C(CH₃)₂C₆H₅ [5],

≡Si—O—C(CH₃)₂C(O)OCH₃ [6],

≡Si—O—C(CH₃)[C(O)OC₂H_{5]}₂ [7],

≡Si—O—CH(CH₃)C₆H₅ [8],

≡Si—O—CH(CH₃)C(O)OCH₃ [9].

The compounds (V) may be high molecular mass or polymeric compounds (P) or low molecular mass compounds (N).

In one preferred embodiment of the invention, the compounds (V) are polymers (P) in which the alkoxysilyl groups of the general formula [1] are covalently bonded by the free valences on the silicon atom to one or more polymer radicals (PR). Similarly, the radicals R¹, R², and R³ may also comprise or represent polymer radicals (PR), these radicals (PR) being attached via a carbon spacer to the carbon atom of the general formula [1]. In this case it is possible as polymer radicals (PR) to employ all organic polymers and organopolysiloxanes. Examples of suitable polymers, in unbranched and branched form, are polyolefins, e.g., polyethylene, polystyrene, polypropylenes, polyethers, polyesters, polyamides, polyvinyl acetates, polyvinyl alcohols, polyurethanes, polyacrylates, epoxy resins, polymethacrylates, and organopolysiloxanes, such as linear, branched, and cyclic organopolysiloxanes and organo-polysiloxane resins, and copolymers thereof.

Examples of polymers (P) in which the polymer radicals (PR) are covalently bonded to the free valences on the silicon atom of the alkoxysilyl groups of the general formula [1] are polyethylenes or polyvinyl acetates which within the chain carry alkoxysilyl groups of the general formula [1].

Examples of polymers (P) in which the polymer radicals (PR) correspond to the radicals R¹, R², and R³ or are part of the radicals R¹, R², and R³ are polysiloxanes of the general formula [10],

≡Si—O—C(R¹)(R²)(CH₂CH₂—[Si(CH₃)₂—O]ₓ—Si (CH₃)₃) [10]

where x is an integer between 10 and 100, and the free valences on the silicon atom that are identified by ≡Si are satisfied by any desired radicals.

Preferred polymers (P) are linear, branched, and cyclic organopolysiloxanes of the general formula [11],

(R⁷₃SiO_{1/2})ₐ(R⁷₂SiO_{2/2})_{b}(R⁷SiO_{3/2})_{c}(SiO_{4/2})_{d} [11]

where
R⁷ adopts the definition of the radical R⁵, and at least one radical R⁷ adopts the definition —O—C(R²)(R²)(R³),
a, b, c, and d denote an integral value of greater than or equal to 0, with the proviso that the sum of a+b+c is at least 1, and
R¹, R², R³, and R⁵ can adopt the definitions indicated above.

The radicals R⁷ are preferably a methyl, ethyl, propyl, butyl, octyl, phenyl, OH group, methoxy, ethoxy, propoxy, butoxy, acetoxy or a group —O—C(R¹) (R²) (R³).

With particular preference the polymers (P) are linear siloxanes which in terminal or lateral position carry alkoxysilyl groups of the general formula [1].

The alkoxysilyl-functional polymers (P) can be prepared using common synthesis techniques that are familiar to the skilled worker. For example, alkoxysilyl-functional polyethylenes can be obtained by coordinative polymerization, by means, for example, of Ziegler-Natta catalysts or metallocene catalysts, or free-radical grafting of a vinyl-functional alkoxysilane that carries groups of the general formula [1] onto a polyethylene. An alkoxysilyl-functional polyvinyl acetate can be obtained, for example, by free-radical polymerization of a vinyl-functional alkoxysilane that carries groups of the general formula [1] with vinyl acetate. For the preparation of an alkoxysilane-modified polymethacrylate that carries groups of the general formula [1], a methacryloyl-functional alkoxysilane can be copolymerized with a methacrylate. The preparation of alkoxysilane-functional polyurethanes is possible, for example, through reaction of an isocyanate-functional prepolymer with an amino-functional alkoxysilane that carries groups of the general formula [1].

Alkoxysilyl-functional polymers (P) can be obtained, for example, by reaction of an α,ω-SiOH-functional siloxane or SiOH-functional silicone resin with silanes of the general formula [12],

R⁵₄₋ₙSi(O—C(R^{′})(R²)(R³))ₙ [12]

or the hydrolysis and condensation products thereof,

where
n has the values 1, 2 or 3 and
R¹, R², R³, and R⁵ have the definitions stated above,

or condensation of the silanes of the general formula [12] or cocondensation of the silanes of the general formula [12] with the silanes of the general formula [13],

YₑSiR⁸₄₋ₑ [13],

or their hydrolysis and condensation products,

where
Y is hydrogen, an OH group, halogen, an alkoxy group having 1-12 carbon atoms, or a carboxyl radical having 1-12 carbon atoms,
R⁸ is an optionally heteroatom-substituted, aliphatic or aromatic hydrocarbon radical having 1-12 carbon atoms, and
e can adopt the values 1, 2, 3, and 4,

or by the technique, known to the skilled worker, of the equilibration of an organopolysiloxane of the general formula [11] with one or more silanes of the general formula [12] or their hydrolysis or condensation products.

In another embodiment of the invention, the compounds (V) are low molecular mass compounds (N) which carry at least one group of the general formula [1]. The low molecular mass compounds (N) are typically in the form of silanes of the general formula [12] above. Employed preferably as compounds (N) are the substances of formulae [14]-[25],

XSi(O—C(CH₃)₃)₃ [14],

X₂Si(O—C(CH₃)₃)₂ [15],

X₃Si(O—C(CH₃)₃) [16],

XSi(O—C(CH₃)₂C₂H₅)₃ [17],

X₂Si(O—C(CH₃)₂C₂H₅)₂ [18],

X₃Si(O—C(CH₃)₂C₅H₅) [19],

XSi(O—CH(CH₃)(C₆H₅))₃ [20],

X₂Si(O—CH(CH₃)(C₆H₅))₂ [21],

X₃Si(O—CH(CH₃)(C₆H₅)) [22],

XSi(O—CH(CH₃)C(O)OCH₃)₃ [23],

X₂Si(O—CH(CH₃)C(O)OCH₃)₂ [24],

X₃Si(O—CH(CH₃)C(O)OCH₃) [25],

and their hydrolysis and condensation products, where
X is Cl, OH, methyl, ethyl, vinyl, phenyl, a carboxyl radical having 1-6 carbon atoms, an alkoxy radical having 1-6 carbon atoms or a metal-oxy radical M—O—, and
M adopts the definitions stated above.

The compounds (V) contain on average 1 to 10 000 alkoxysilyl groups of the general formula [1] per molecule. Where the compound (V) is a low molecular mass compound (N), the number of alkoxysilyl groups of the general formula [1] is preferably 1. The number of radicals —O—C (R¹)(R²)(R³) per alkoxysilyl group is 1, 2, 3 or 4. More preferably the number is 2 or 3.

Where the compounds (V) are polymers (P), the number of alkoxysilyl groups of the general formula [1] is preferably 1 to 10 000. More preferably the number of alkoxysilyl groups of the general formula [1] is 5 to 1000. In this case the number of radicals —O—C (R¹)(R²)(R³) per alkoxysilyl group is 1, 2 or 3. More preferably the number is 2 or 3.

The polymer blends (A) may further comprise organic polymers and siloxanes. Preferred polymers and siloxanes are those which carry groups which are able by reaction with water to form SiOH groups or to enter into a condensation reaction with SiOH-carrying molecules. Examples of organic polymers and siloxanes of these kinds are SiOH-functional silicone oils and silicone resins, and also siloxanes and organic polymers which carry hydrolyzable Si—Oalkyl groups, of the kind described in DE 10 2006 022 095 A1, for example.

Preferred catalysts (K) are Lewis acids and Brönsted acids. Examples of suitable Lewis acids are tin, tin oxide, and tin compounds, such as dibutyltin dilaurate (DBTL), titanium, titanium oxide, and titanium compounds, such as titanium(IV) isopropoxide, copper, copper oxide, and copper compounds, such as copper(I) trifluoromethanesulfonate, iron, iron oxide, and iron compounds, such as iron(III) chloride and iron(III) acetylacetonate, manganese, manganese oxide, and manganese compounds, such as manganese(II) acetyl-acetonate, aluminum, aluminum oxide, and aluminum compounds, such as aluminum(III) chloride, aluminum(III) isopropoxide, and trimethylaluminum, boron, boron oxide, and boron compounds, such as boron trichloride, zirconium, zirconium oxide, and zirconium compounds, such as Zr(IV) acetylacetonate, gallium, gallium oxide, and gallium compounds, an example being gallium(III) acetylacetonate, cerium, cerium oxide, and cerium compounds, such as cerium(III) chloride, and zinc, zinc oxide, and zinc compounds, such as zinc laurate and zinc pivalate, for example. Examples of suitable Brönsted acids are carboxylic acids, such as lauric acid, sulfonic acids, such as trifluoromethanesulfonic acid, p-toluenesulfonic acid, and dodecylbenzenesulfonic acid, mineral acids, such as hydrochloric acid, nitric acid, and phosphoric acid, for example. Also suitable, moreover, are compounds which on irradiation with high-energy radiation, such as UV light or electron beams, for example, give up protons, with decomposition. Examples that may be given of such compounds include diaryliodonium compounds, such as {4-[(2-hydroxytetradecyl)oxy]phenyl}phenyliodonium hexafluoroantimonate, diphenyliodonium nitrate, bis(4-tert-butylphenyl)iodonium p-toluenesulfonate, bis(4-tert-butylphenyl)iodonium trifluoromethanesulfonate, triarylsulfonium compounds, such as 4-(thiophenoxyphenyl)diphenylsulfonium hexafluoroantimonate, (4-bromophenyl)diphenylsulfonium trifluoromethanesulfonate, and N-hydroxynaph-thalimide trifluoromethanesulfonate, and also 2-(4-methoxystyryl)-4,6-bis(trichloromethyl)-1,3,5-triazine.

Employed more particularly are catalysts (K) which accelerate a condensation between two silanol groups, between a silanol group and an alkoxysilyl group, between a silanol group and an Si—Cl group, or between an alkoxysilyl group or Si—Cl group and water. In addition, mixtures of different catalysts (K) can be employed. The catalyst (K) is used preferably in a concentration of at least 10 ppm, more preferably at least 0.1% by weight, based in each case on the polymer blend (A). The catalyst (K) is used preferably in a concentration of not more than 20%, more preferably not more than 10%, more particularly not more than 2%, by weight, based in each case on the polymer blend (A).

The polymer blends (A) may be solvent-free or else solvent-containing. Examples of suitable organic solvents are benzines, n-heptane, benzene, toluene, xylenes, halogenated alkanes having 1 to 6 carbon atoms, ethers, esters such as ethyl acetate, for example, ketones such as methyl ethyl ketone, for example, amides such as dimethylacetamide, for example, and dimethyl sulfoxide. In one preferred embodiment of the invention the polymer blends (A) are solvent-free. In another preferred embodiment of the invention the polymer blends (A) are in the form of aqueous emulsions or dispersions.

The polymer blends (A) may further comprise additives (W), examples being flow control assistants, water scavengers, fungicides, flame retardants, dispersing assistants, dyes, plasticizers, heat stabilizers, release force modifiers, antimisting additives of the type described in WO 2006/133769, for example, fragrances, surface-active substances, adhesion promoters, fibers, such as glass fibers and polymeric fibers, for example, light stabilizers such as UV absorbers and free-radical scavengers, and particulate fillers, such as carbon black, for example, pigments such as black iron oxide, for example, quartz, talc, fumed silica, chalks or aluminum oxide. Employed with particular preference as additives (W) are precipitated and fumed silicas, and also mixtures thereof. The specific surface area of these fillers ought to be at least 50 m²/g, or preferably in the range from 100 to 400 m²/g as determined by the BET method. The stated silica fillers may be hydrophilic in nature or may have been hydrophobicized by known techniques. The amount of additives (W) in the polymer blends (A) is typically in the range from 0% to 70% by weight, preferably 0% to 50% by weight.

The polymer blends (A) may further comprise compounds (I) which form free radicals under thermal influence or through irradiation with UV light. Examples of these compounds (I) are thermal and photochemical polymerization initiators which are known to the skilled worker, of the kinds described in the “Handbook of Free Radical Initiators” by E. T. Denisov, T. G. Denisova, and T. S. Pokidova, Wiley-Verlag 2003, for example.

Examples of thermal initiators (I) are tert-butyl peroxide, tert-butyl peroxopivalate, tert-butyl peroxo-2-ethylhexanoate, dibenzoyl peroxide, dilauroyl peroxide, azobisisobutyronitrile, tert-butyl peroxobenzoate, or cumyl hydroperoxide. Examples of photoinitiators (I) are benzophenone, 2-hydroxy-2-methyl-1-phenyl-1-propanone, 1-hydroxycyclohexyl phenyl ketone or methyl benzoylformate.

The polymer blends (A) can be produced by mixing the individual components with one another in any order. The production of the polymer blends (A) may take place continuously or discontinuously.

Additionally provided by the invention is a method for curing the polymer blends (A) by heating of the polymer blends (A) at 5° C. to 300° C. for 1 s to 48 h. Where the polymer blends (A) comprise, as compounds (V), polymers (P) whose polymer radicals (PR) are organopolysiloxanes, the curing is carried out preferably at a temperature of 5° C. to 190° C. Where, in contrast, the polymer blends (A) comprise, as compounds (V), low molecular mass compounds (N) or polymers (P) whose polymer radicals (PR) are organic polymer radicals, curing takes place at 5° C. to 300° C.

For curing, the polymer blends (A) are brought preferably to a temperature of at least 50° C., more particularly at least 80° C. For curing, the polymer blends (A) are brought preferably to a temperature of at most 180° C., more particularly at most 150° C.

Energy sources used for crosslinking the polymer blends (A) by heating are preferably ovens, examples being forced-air drying cabinets, heating tunnels, heated rollers, heated plates, infrared radiant heaters, or microwaves. The polymer blends (A) can also be crosslinked by irradiation with ultraviolet light or electron beams.

In one particularly preferred embodiment of the method, curing is accomplished by thermal decomposition of the alkoxysilyl group of the general formula [1], with formation of silanol groups ≡Si—OH, and by subsequent condensation of the silanol groups. In the course of the thermal decomposition of the alkoxysilyl groups of the general formula [1], vinyl-functional compounds may be released as further cleavage products.

One particularly preferred embodiment of the method employs polymer blends (A) which in the course of their curing do not release volatile organic or inorganic compounds. Polymer blends of this kind are present, for example, when the radicals R¹, R² or R³ of the compounds (V) represent or comprise nonvolatile polymer radicals and when the other constituents of the blend (A) as well are nonvolatile under the curing conditions. Polymer blends (A) of this kind, releasing no volatile organic or inorganic compounds in the course of curing, are likewise obtained by polymerizing the cleavage products formed in the course of curing from the compounds (V), under the curing conditions, to give nonvolatile compounds. For example, the curing of a polymer blend (A) which comprises tris(1-phenylethoxy)-vinyl silane as low molecular mass compound (N) leads to the elimination of styrene, which can be polymerized to polystyrene under the curing conditions.

With particular preference the polymer blend (A) is cured without ingress of (atmospheric) moisture.

The polymer blends (A) may be processed as 1-component (1K) or 2-component (2K) systems. In the form of a 1K system, the polymer blend (A) is storable. For curing, the blend (A) is heated, as described, without addition of other components, In the case of a 2K system, the polymer blend (A) is not storable, and the potlife of the polymer blend (A) is greatly restricted. The compound (V) and the catalyst (K) must be stored and transported separately from one another and must not be mixed until shortly before processing together with further components to form the polymer blend (A).

The polymer blends (A) and also the crosslinking products produced from them can be employed for all purposes for which crosslinked siloxanes, more particularly elastomeric siloxanes, silicone resins, and crosslinked organic polymers are typically employed.

The polymer blends (A) are especially suitable for coating textile fabrics, examples being wovens, nonwovens, drawn-loop knits, laid scrims, formed-looped knits, felts or warp knits. These textile fabrics may be fabricated from natural fibers, such as cotton, wool, silk, etc., or else from synthetic fibers such as polyester, polyamide, aramid, etc. Mineral fibers as well, such as glass or silicates, or metal fibers, may also provide a basis for the fabrication of the textiles. One preferred utility is the use of the polymer blends (A) for coating airbag fabrics.

The polymer blends (A) may also be used, furthermore, to coat surfaces composed of mineral materials, such as stones, tiles, slabs, concrete, plasters, plastics, natural substances or metals.

The polymer blends (A) constitute, in particular, coating materials suitable for heat-resistance coatings on metals. Depending on their composition, the cured coating materials may be used at up to a temperature of 700° C. Applications for high-temperature coatings of this kind include, for example, exhaust, grill, engine-component, pot-and-pan, bakeware, oven and waffle-iron coatings. The cured polymer blends (A) may also improve the corrosion resistance of the materials coated.

A further possibility for use of the polymer blends (A) is in the production of cured polymer coatings on paper, polymeric films (e.g., polyethylene films, polypropylene films, polyester films), wood, cork, silicatic and metallic substrates, and other polymeric substrates, such as polycarbonate, polyurethane, polyamide and polyester, for example.

As far as the paper employed is concerned, the paper grades in question may be low-grade types, such as absorbent papers, including kraft paper which is in the raw state, i.e., has not been pretreated with chemicals and/or natural polymeric substances, and has a weight of 60 to 150 g/m², unsized papers, papers of low freeness value, mechanical papers, unglazed or uncalendered papers, papers which are smooth on one side owing to the use of a dry-glazing cylinder during their production, without additional complex measures, uncoated papers, or papers produced from paper waste.

Alternatively the paper may be a high-grade paper type, such as low-absorbency papers, sized papers, papers with a high freeness value, chemical papers, calendered or glazed papers, glassine papers, parchmentized papers or precoated papers.

The films and papers coated with the cured polymer blends (A) are suitable, for example, for producing release papers, backing papers, and interleaving papers, including interleaving papers which are employed in the production of, for example, cast films or decorative foils, or of foam materials. They are additionally suitable for producing release, backing, and interleaving papers, films, and cloths for equipping the reverse faces of self-adhesive tapes or self-adhesive sheets, or the written faces of self-adhesive labels.

The polymer blends (A) are also suitable for equipping packaging material, such as that made from paper, cardboard boxes, metal foils, and drums, which are intended, for example, for the storage and/or transport of sticky products, such as adhesives and sticky foods. A further example of the use of the surfaces coated with the crosslinked polymer blends (A) is in the equipping of supports for the transfer of pressure-sensitive adhesive layers in the context of the so-called transfer process.

The polymer blends (A) are applied to the stated surfaces employing techniques that are familiar to the skilled worker, such as knife coating processes, dipping processes, extrusion processes, injection or spraying processes, and spin-coating processes. All kinds of roller coatings as well, such as gravure rolls, padding or application via multiple-roll systems are possible, as is screen printing. The layer thickness on the surfaces to be coated is preferably 0.005 to 1000 μm, more preferably 0.5 to 80 μm.

The polymer blends (A) are likewise suitable as impression compounds and for producing moldings. Hence polymer blends (A) which comprise an alkoxysilane-functional polyolefin as compound (V) may be used, for example, for producing cable sheathing and pipes. Polymer blends (A) may likewise find use for the production of silicone moldings.

The polymer blends (A) may also be used as adhesives, sealants, and jointing compounds, or cementing compounds, and also as hotmelt adhesives. Possible applications are situated, for example, in window construction, in the production of aquariums or glass cabinets, and for the insulation of electrical or electronic devices. Suitable substrates in these contexts typically include mineral substrates, metals, plastics, glass, and ceramics.

All of the above symbols in the above formulae have their definitions in each case independently of one another. In all formulae the silicon atom is tetra-valent.

Unless indicated otherwise, all amounts and percentages are given by weight, all pressures are 0.10 MPa (abs.), and all temperatures are 20° C.

### EXAMPLE 1

### Curing of a Polymer Blend

A mixture containing 1.60 g (O.533 mmol) of an α,Ω-SiOH-terminated polydimethylsiloxane (Mw=3000 g/mol), 0.15 g (0.495 mmol) of tris(tert-pentoxy)silanol [CAS No. 17906-35-3], and a solution of 6 mg of Cu(I) trifluoromethylsulfonate-toluene complex [CAS 48209-28-5] in 0.2 ml of ethyl acetate is heated to 140° C. in the absence of moisture. After 1 minute a cured polymer is obtained which is insoluble in common organic solvents such as THF, ethyl acetate, and toluene.

### EXAMPLE 2

### Preparation of a Tert-Butoxysilyl-Functional Siloxane

A solution of 2.50 g (10 mmol) of sodium tris(tert-butoxy)silanolate in 10 ml of cyclohexane is admixed dropwise with 1.02 g (5 mmol) of 1,2-dichloro-1,1,2,2-tetramethyldisiloxane and the mixture is heated at 80° C. for 3 hours. After removal of the precipitate by filtration, the solvent is removed by distillation. This gives 2.6 g of a colorless oil.

### EXAMPLE 3

### Curing of a Polymer Blend

A mixture containing 9.00 g of tert-butoxysilyl-functional siloxane from example 2 and 0.50 g of aluminum isopropoxide are heated at 150° C. for 1 hour. Formed from the liquid mixture is an infusible solid which is insoluble in common organic solvents such as THF, ethyl acetate, and toluene.

### EXAMPLE 4

### Curing of a Polymer Blend

A mixture containing 0.26 g of a bis[(3-methyldi-methoxysilyl)propyl]polypropylene oxide [CAS No. 75009-88-0], 0.12 g (0.40 mmol) of tris(tert-pentoxy)silanol [CAS No. 17906-35-3], and a solution of 11 mg of Cu(I) trifluoromethylsulfonate-toluene complex [CAS 48209-28-5] in 0.2 ml of ethyl acetate is heated to 130° C. in the absence of moisture. After 10 minutes a tack-free, through-crosslinked polymer is obtained which can no longer be dissolved in common organic solvents such as THF, ethyl acetate, and toluene.

### EXAMPLE 5

### Synthesis of Tris(Tert-Butoxy)Vinyl Silane

A solution of 191 ml (1.30 mol) of vinyltrichlorosilane in 2100 ml of hexane is admixed over the course of 6 hours at 0° C. with 574 g of potassium tert-butoxide. The mixture is stirred at room temperature for 2 hours and under reflux for 15 hours. Following removal of the precipitate by filtration, the solvent is evaporated off and the residue is subjected to fractional distillation. This gives 63 g of a colorless oil (boiling point 75° C., 3 mbar).

### EXAMPLE 6

### Preparation and Thermal Curing of a Thermally Crosslinkable Polyethylene

A mixture containing 2.70 g of polyethylene (Mn=1600 g/mol, Mw=4000 g/mol), 0.27 g of vinyl tris(tert-butoxy)silane and 20 μl of tert-butyl peroxy-benzoate is heated at 120° C. for 4 hours. For the curing of the colorless tris(tert-butoxy)silane-functional polyethylene obtained by cooling to room temperature, 0.50 g of the polymer is heated with 8 mg of Cu(I) trifluoromethylsulfonate-toluene complex [CAS 48209-28-5], or 10 mg of dodecylbenzenesulfonic acid at 180° C. for 10 minutes. In the course of this heating procedure, the melt undergoes conversion to an infusible solid.

### EXAMPLE 7

### Preparation of a Tert-Butoxysilyl-Functional Silicone Oil

A solution of 20.0 g of di(tert-butoxy)diacetoxysilane in 300 ml of methyl isobutyl ketone is admixed with 15.0 g of triethylamine and 1.2 ml of water. The mixture is heated at 60° C. for 4 hours. Following addition of 2.00 ml of trimethylchlorosilane and 2.00 ml of triethylamine, the mixture is heated at 80° C. for 1 hour. The solvent is removed by distillation and the residue is taken up in ethyl acetate. Washing of the solution with water, drying of the organic phase by means of magnesium sulfate, and distillative removal of the solvent give 9.30 g of a colorless oil.

### EXAMPLE 8

### Curing of a Polymer Blend

A solution of 10 mg of Cu(I) trifluoromethylsulfonatetoluene complex [CAS 48209-28-5] in 0.2 ml of ethyl acetate is stirred into a mixture of 1.00 g of the siloxane described in example 7 and 10.0 g of an α,ω-SiOH-terminated polydimethylsiloxane (Mw=6000 g/mol). Heating of the mixture at 140° C. for 5 minutes produces a colorless solid which can no longer be dissolved in common organic solvents such as THF, ethyl acetate, and toluene.

### EXAMPLE 9

### Preparation of a Tert-Butoxysilyl-Functional Silicone Oil

A solution of 190 g of an α,ω-SiOH-terminated polydi-methylsiloxane (Mw=6000 g/mol) in 1500 ml of methyl isobutyl ketone is admixed with 43.0 g of triethylamine and then with 50.0 g of di(tert-butoxy)diacetoxysilane, and the mixture is heated at 60° C. After 1 hour, 15.0 ml of water and, after a further hour, a mixture of 15.0 ml of trimethylchlorosilane and 15 ml of triethylamine are added. After a further hour, the mixture is cooled to room temperature, and the precipitate formed is removed by filtration. Following distillative removal of the solvent, the oily residue is taken up in ethyl acetate and washed with water. Drying of the organic phase by means of magnesium sulfate and distillative removal of the solvent give 215 g of a colorless oil.

### EXAMPLE 10

### Curing of a Polymer Blend

The tert-butoxy-functional silicone oil described in example 9 can be cured thermally or by UV radiation: A solution of 0.03 g of triphenylsulfonium trifluoromethanesulfonate in 0.5 ml of acetone is mixed with 5.00 g of the siloxane described in example 9. The mixture is applied to a glass plate in a layer thickness of approximately 100 using a doctor blade. After the acetone has been evaporated, the coating is cured by UV irradiation (40 s, UVA-Cube® from Dr. Höhnle AG, radiation density: 150 mW/cm²). This gives a tack-free coating which can no longer be dissolved in common organic solvents such as THF, ethyl acetate, and toluene.

A solution of 0.10 g of dodecylbenzenesulfonic acid in 0.5 ml of ethyl acetate is mixed with 5.00 g of the siloxane described in example 9. The mixture is applied to a glass plate in a layer thickness of approximately 100 μm, using a doctor blade. Heating of the film at 140° C. for 5 minutes leads to the formation of a tack-free coating which can no longer be dissolved in common organic solvents such as THF, ethyl acetate, and toluene.

### EXAMPLE 11

### Preparation of a Tert-Butoxysilyl-Functional Silicone Resin

A solution of 300 g of a silicone resin (resin of composition (Me₂SiO_{2/2})_{0.1}(MeSiO_{3/2})_{0.4}(PhSiO_{3/2})_{0.5}(O_{1/2}L)_{0.4}with L independently at each occurrence hydrogen or ethyl radical; Mw=3000 g/mol; OH group content of 5.0% by weight) in 1000 ml of methyl isobutyl ketone is admixed with 26.0 g of triethylamine and then with 30.0 g of di(tert-butoxy)diacetoxysilane, and the mixture is heated at 60° C. After 1 hour, 9.00 ml of water and, after a further hour, a mixture of 15.0 ml of trimethylchlorosilane and 15 ml of triethylamine are added. After a further hour, the mixture is cooled to room temperature, and the precipitate formed is removed by filtration. Following distillative removal of the solvent, the residue is taken up in ethyl acetate and washed with water. Drying of the organic phase by means of magnesium sulfate and distillative removal of the solvent give 305 g of a colorless solid.

### EXAMPLE 12

### Curing of a Polymer Blend

A solution of 10 g of the silicone resin described in example 11 in 10 ml of ethyl acetate is admixed with 0.5 g of Cu(I) trifluoromethylsulfonate-toluene complex [CAS 48209-28-5]. The mixture is applied to a glass plate in a layer thickness of approximately 100 μm, using a doctor blade. Heating of the mixture at 140° C. for 5 minutes leads to the formation of a tack-free coating which can no longer be dissolved in common organic solvents such as THF, ethyl acetate, and toluene.

1.-9. (canceled)

10. A method for producing coatings, silane-crosslinked moldings, and adhesives and sealants from a crosslinkable polymer blend (A) comprising curing said polymer blend, wherein the polymer blend comprises at least one compound (V) which bears at least one alkoxysilyl group of the formula [1],
≡Si—O—C(R¹)(R²)(R³) [1]
the compounds (V) being linear or branched organopolysiloxanes of the formula [11],
(R⁷₃SiO_{1/2})ₐ(R⁷₂SiO_{2/2})_{b}(R⁷SiO_{3/2})_{c}(SiO_{4/2})_{d} [11]
or being a low molecular weight compound (N) which bears at least one group of the formula [1], and a catalyst (K) which catalyzes curing of the polymer blend in the absence of water,
where
R¹, R², and R³ each independently is hydrogen, halogen, and Si—C bonded organic radical where
R¹, R², and R³ may be joined to one another, or is a divalent radical attached via a carbon atom which joins two alkoxysilyl groups of the formula [1], with the proviso that not more than two of the radicals R¹, R², and R³ are hydrogen, and alkoxysilyl radicals of the formula ≡Si—O—CH₂−R⁴ are excluded, and
R⁴ is an unbranched aliphatic hydrocarbon radical having 1-12 carbon atoms,
R⁵ is hydrogen, halogen, an unsubstituted or substituted aliphatic or aromatic hydrocarbon radical having 1-12 carbon atoms, an OH group, an —OR⁶ group, —OC(O)R⁶ group or a metal-oxy radical M—O—,
R⁶ is hydrogen, an unsubstituted or substituted aliphatic or aromatic hydrocarbon radical having 1-12 carbon atoms, and
M is a metal atom, any free valences of which are satisfied by ligands,
R⁷ has the definition of radical R⁵, and at least one radical R⁷ is —O—C(R¹)(R²)(R³),
a, b, c, and d denote an integral value greater than or equal to 0, with the proviso that the sum of a+b+c is at least 1
wherein polymer blends (A) which form SiO₂ on crosslinking are excluded, and, with the proviso that, if the compounds (V) are low molecular weight compounds (N), the polymer blends (A) comprise organic polymers which are reactive with water to form SiOH groups or to enter into a condensation reaction with SiOH-carrying molecules.

11. The method of claim 10, wherein at least one catalyst (K) is selected from the group consisting of Lewis acids, Brönsted acids, Lewis bases, and Brönsted bases.

12. The method of claim 10, wherein at least one catalyst (K) is selected from the group consisting of tin, tin oxide, and tin compounds other than tin oxide, titanium, titanium(IV) isopropoxide, copper, copper oxide, and copper compounds other than copper oxide, iron, iron(III) chloride, iron(III) acetylacetonate, manganese, manganese oxide, and manganese compounds other than manganese oxide, aluminum, aluminum(III) chloride, aluminum(III) isopropoxide, trimethylaluminum, boron, boron oxide, and boron compounds other than boron oxide, zirconium, Zr(IV) acetylacetonate, gallium, gallium oxide, and gallium compounds other than gallium oxide, cerium, cerium oxide, and cerium compounds other than cerium oxide, zinc, zinc laurate, zinc pivalate, carboxylic acids, mineral acids, and compounds which on irradiation with high-energy radiation give up protons with decomposition,

13. The method of claim 10, wherein the alkoxysilyl group of the formula [1] has the formula [2],
≡Si(R⁵)—O—C(R¹)(R²)(R³) [2]
where
R⁵ is hydrogen, halogen, an unsubstituted or substituted aliphatic or aromatic hydrocarbon radical having 1-12 carbon atoms, an OH group, an —OR⁶ group, —OC(O)R⁶ group or a metal-oxy radical M—O—,
R⁶ is an unsubstituted or substituted aliphatic or aromatic hydrocarbon radical having 1-12 carbon atoms, and
M is a metal atom, any free valences of which are satisfied by ligands.

14. The method of claim 10, wherein the radicals R¹, R², and R³ are hydrogen, chlorine, an unsubstituted or substituted aliphatic or aromatic hydrocarbon radical or a siloxane radical attached via a carbon atom, or are a carbonyl group —C(O)R⁶, a carboxylic ester group —C(O)OR⁶, a cyano group —C≡N or an amide group —C(O)NR⁶₂, and the radical R⁶ is hydrogen, methyl, ethyl, propyl, vinyl or phenyl.

15. The method of claim 13, wherein the radicals R¹, R², and R³ are hydrogen, chlorine, an unsubstituted or substituted aliphatic or aromatic hydrocarbon radical or a siloxane radical attached via a carbon atom, or are a carbonyl group —C(O)R⁶, a carboxylic ester group —C(O)OR⁶, a cyano group —C≡N or an amide group —C(O)NR⁶₂, and the radical R⁶ is hydrogen, methyl, ethyl, propyl, vinyl or phenyl.

16. A method for curing a coating, a silane-crosslinked molding, adhesive, or a sealant comprising a crosslinkable polymer blend (A) of claim 10, comprising heating the polymer blend (A) at 5° C. to 300° C. for 1 s to 48 h.

17. The method of claim 16, which takes place in the absence of water.

18. The method of claim 10, wherein the catalyst (K) is a photocatalyst.

19. The method of claim 10, wherein the low molecular weight compound (N) is a monosilane or hydrolysis or condensation product thereof.

20. The method of claim 19, wherein the monosilane is selected from the group consisting of
XSi(O—C(CH₃)₃)₃,
X₂Si(O—C(CH₃)₃)₂,
X₃Si(O—C(CH₃)₃),
XSi(O—C(CH₃)₂C₂H₅)₃
X₂Si(O—C(CH₃)₂C₂H₅)₂,
X₃Si(O—C(CH₃)₂C₅H₅),
XSi(O—CH(CH₃)(C₆H₅))₃,
X₂Si(O—CH(CH₃)(C₆H₅))₂,
X₃Si(O—CH(CH₃)(C₆H₅)),
XSi(O—CH(CH₃)C(O)OCH₃)₃,
X₂Si(O—CH(CH₃)C(O)OCH₃)₂,
X₃Si(O—CH(CH₃)C(O)OCH₃),
and their hydrolysis and condensation products,
where
X is Cl, OH, methyl, ethyl, vinyl, phenyl, a carboxyl radical having 1-6 carbon atoms, an alkoxy radical having 1-6 carbon atoms or a metal-oxy radical M—O—.

21. The method of claim 10, wherein the polymer blend (A) comprises an α,ω-SiOH-terminated polydimethylsiloxane and tris(t-pentoxy)silanol.

22. The method of claim 10, wherein the polymer blend (A) comprises a t-butoxysilyl-functional siloxane.
